(19) United States
(12) Patent Application Publication
(10) Pub. No.: US 2005/0055694 A1
(43) Pub. Date: Mar. 10, 2005

(54) Dynamic load balancing resource allocation

(75) Inventor: Man-Ho Lawrence Lee, Milpitas, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, LP, Houston, TX (US)

(21) Appl. No.: 10/655,075

(22) Filed: Sep. 4, 2003

(51) Int. Cl. G06F 9/46

(52) U.S. Cl. 718/100

(57) ABSTRACT

A method, a system, and a computer readable medium embodying a computer program with code for dynamic load balancing resource allocation. A desired allocation of resources is received for servicing a plurality of consumer group requests and determining an actual allocation of the resources for a present operational period. A temporary allocation of the resources for a next operational period relative to the desired allocation and the actual allocation is determined and tile resources allocated to the consumer group requests in the next operational period according to the temporary allocation. Consumer group requests to be serviced by the resources are selected based upon availability of the consumer groups requests and the amount of consumer groups requests being presently serviced.

### BACKGROUND

Network resources must be allocated efficiently in a computer network in order to ensure the network performs efficiently. For instance, multiple consumers share multiple resources of the computer network such that different consumers may be trying to access the same resource at the same time. However, the resource can only service a single consumer at a time. Therefore, it is necessary to allocate resource usage among the consumers. The allocation can be performed in many different ways.

Typically, resource allocation is priority based. For example, process priority is often used to determine how a process dispatcher module allocates CPU cycles to different processes and for how long. Alternatively, the send engine implemented at the CPU's point of presence in the network determines what network request to serve next by taking priority of different pending requests. It is also possible that the transport layer driver determines which incoming ports to serve first by the priority of the requests queued at the head of the queues. In each of the examples, a priority is used to determine the order consumers are serviced.

Priority based resource allocation schemes allow clients to differentiate resource usage of different requirements and let such implementations provide differentiated services to the client. Usually consumers or their requests are tagged with a priority level such that entities with a higher priority level are serviced before entities with a lower priority level.

However, priority schemes do not always efficiently allocate resources among consumers. For instance, a strict priority scheme, in which higher priority tasks are always served first, and probabilistic priority schemes, in which higher- priority tasks have a higher probability of being serviced first, can result in starvation. For a strict priority scheme, if there are too many high priority requests, starvation occurs with the low priority requests because they are not serviced within a bound and reasonable amount of time. A similar starvation problem occurs with a probabilistic priority scheme if too much attention is given to high priority traffic thereby causing low priority traffic to miss certain time-bound requirements. For a priority scheme which manages resources on1 a relative basis, the amount of resources consumed by a particular group of consumers depends on the number of consumers with different priority levels A consumer having the same priority level might not get the same quality of service every time because the number of consumers with different priority levels varies.

Specific types of resource allocation schemes are first-in/first-out, round robin, weighted round robin, strict priority and probabilistic priority. In a first-ill/first-out (FIFO) scheme, requests are serviced in the order they are received Requests received first are also the first to be serviced. The scheme is considered to be fair, but different requests with different strict performance requirements might not be serviced satisfactorily.

In a round robin scheme, each consumer has an equal chance of accessing the shared resource. The shared resources are divided evenly among the consumers such that all consumers are treated equally. This is an improvement over the FIFO scheme, as it prevents a large amount of a particular type of requests from blocking all others for accessing the resources. However, it does not differentiate among different types of requests. Such differentiation is needed for providing different quality of services.

A weighted round robin scheme allows each consumer to get a quantifiable share of the resource by having the resource management logic serve each consumer in a prescribed ratio. However, historical data is not taken into account. Therefore, bursty requests are usually serviced less than ideally because there are times when the resources are not used and there are times when many requests are held off. Accordingly, the average number of requests serviced is usually less than maximally allowed.

Since resource allocation is difficult to handle when consumer behavior is unpredictable, historical data is used. However, in and of itself, historical data doesn't provide for reliable forecasts of resource requests for the purpose of resource allocation. Hence, additional logic is required to make use of the historical data to infer how resources should be allocated and try meeting the service level requirements as desired by various clients.

### SUMMARY

A method and system of allocating resources to consumer groups is described. A desired allocation of a resource for servicing the consumer group requests is chosen. The actual allocation of resources is determined for a present operational period. By using the desired allocation and the actual allocation a temporary allocation of the resource for the next operational period is chosen. Accordingly, the resources for the next period are allocated according to the temporary allocation. The consumer group requests are chosen to be serviced based upon the availability of the requests and the number of requests being presently served.

After the consumer group requests are chosen to be serviced, the consumer load for each consumer group may be calculated in response to the number of consumer group requests serviced. Each consumer group request is associated with a consumer group. A busyness factor for each network resource is associated with the number of requests being serviced and is updated in a calculation done in response to the servicing of tie collection of requests. The least busy network resource is selected to service the consumer group requests in response to the consumer load and the busyness factor. In one implementation, such request arbitration and load calculation process can be done for a single request of various sizes at a time. In other words, a single consumer group request is chosen to be serviced by the least busy resource, and the busyness factor for such network resource is updated in response to the servicing of such single request.

In one embodiment of the invention, the method above can be performed via a computer readable medium that embodies a computer program with code for the dynamic load balancing resource allocation. It includes: code for causing a computer to determine an actual allocation of the resources for a present operational period; code for causing the computer to determine a temporary allocation of the resources for a next operational period relative to the desired allocation and the actual allocation; code for causing the computer to allocate the resources to the consumer group requests in the next operational period according to the temporary allocation; and code for causing the computer to select consumer group requests to be serviced by the resources based upon the amount of requests being presently serviced.

The computer readable medium may further include: code means for causing the computer to calculate a consumer load for each consumer group in response to the number of consumer groups requests being serviced, wherein each consumer group request is associated with a consumer group; code means for causing the computer to calculate a busyness factor for each resource in response to the number of requests being serviced; and code means for causing the computer to select the least busy resource to service the consumer group requests based on the consumer load and the busyness factor.

In another embodiment, a system is configured for dynamic load balancing resource allocation. The system includes a resource to be allocated for servicing consumer group requests, and a request arbitrator. As implemented in this configuration, the request arbitrator includes means for determining for various consumer groups an actual allocation of the resource for a present operational period, means for determining for various consumer groups a temporary allocation of tile resource for a next operational period relative to the desired allocation and the actual allocation of the consumer group, means for allocating the resources to the consumer group requests in the next operational period according to the temporary allocation, and means for selecting consumer group requests to be serviced by the resource based upon the amount of requests being presently serviced.

In many instances there are at least two resources. Moreover, for load balancing the request arbitrator typically may further include means for calculating a consumer load for each consumer group in response to tile number of consumer groups requests being serviced, means for calculating a busyness factor for each resource in response to the number of requests being serviced, and means for selecting the least busy resource to service the consumer group requests based on tile consumer load and the busyness factor.

These principles can be applied, among others, to various parts of a computer system, computer networks as well as non-computerized environments. For example, the algorithm may be embedded inside the process control logic of an operating system kernel to replace traditional priority based algorithm. This algorithim can be also used in virtual partitioning of processor resources, disk resources, memory resources, etc. It is noted that these examples are not exhaustive and other implementations are possible without departing from the spirit of the principles described herein.

### BRIEF DESCRIPTION OF THE DRAWINGS

The accompanying drawings, which are incorporated in and constitute a part of this specification, illustrate representative embodiments of the invention. Wherever- convenient, the same reference numbers will be used throughout the drawings to refer to the same or like elements.

FIG. 1 is a block diagram illustrating a request arbitrator and network.

FIG. 2 is a flowchart showing a method to dynamically allocate resources with consumer to resource binding restriction.

FIG. 3 is a flowchart showing a method to dynamically allocate resources without any consumer to resource binding restriction.

FIG. 4 is a flowchart showing a method to dynamically allocate resources with the performance characteristics of all consumers and resources predetermined.

FIG. 5 is a flowchart showing a method of executing the request arbitration part of one operational period. Such request arbitration part is done a synchronously with respect to the request distributing part.

FIG. 6 is a flowchart showing a method of executing the request distributing part of one operational period. Such request distributing part is done a synchronously with respect to the request arbitration part.

FIG. 7 is a flowchart showing a method of executing one operational period with the request arbitration part and request distributing part synchronously done.

FIG. 8 is a flowchart showing a method of processing the completion of requests.

### DETAILED DESCRIPTION

The description herein outlines representative embodiments of the invention. However, there could be further variations in the embodiments of the invention.

The meaning imparted to the terms below and throughout this paper is intended not as a limitation but merely to convey character or property relevant to the present invention. Where the terms have a special meaning or a meaning that is inapposite to accepted meaning in the art, the value of such meaning is not intended to be sacrificed to well-worn phrases or terms.

Group—A collection of consumers that is categorized to share the same characteristics. Characteristics refer to how the consumers use the available resources. For example, a collection of requests that is going to a particular collection of remote system nodes that are fifteen kilometers away from the sender can be grouped together because the requests share the same latency characteristics.

Consumer—An entity that produces consumer requests which in turn consumes shared resources For example, a process can generate requests to other processors. Such requests consume network bandwidth and send engine buffering spaces.

Consumer Request—A unit of work to be serviced by a shared resource owner/producer/service agent. For example, a process (consumer) may create a 10 k-byte request message (consumer request) for delivery to a remote node that is 5 km away. The delivery of such message consumers send engine buffering and network bandwidth. These resources are owned/produced by send engine ASIC and network routing units.

Resource producer/owner/service agent—An entity that owns a durable resource or produces non-durable resources for cnsumptin. In this context, it is composed of a resource servicing queue for queuing up pending consumer requests and processing logic for servicing the requests in such queued order. For example, a send engine that resides on a processor owns a limited amount of buffers for delivering Outgoing packets. Due to the size of the send engine buffers and the send engine's speed of data delivery (implemented according to a specification), the send engine can only accept packets up to a certain maximum rate. The send engine buffers are durable resources that produce non-durable network bandwidth resource for consumption. In this case, the send engine is a resource producer.

Requests arbitrator—The exclusive controller of the resource allocation logic. All requests have to be regulated by this entity before they can get access of the resources' request servicing queue. Such arbitrator controls how available resources should be provisioned to groups of consumers. For example, if this algorithm is applied to a send engine ASJC with 16 independent send engines the request arbitrator controls how outgoing client requests are serviced by those send engines. The request arbitrator selects which send engine will process which request according to some previously defined criteria.

Operational period—A session of time in which data is being collected and operational parameters are calculated. The current operational parameters are based on data obtained from the previous operational periods. More particularly, operational parameters are some resource allocation ratios to determine how incoming requests from different consumer groups are serviced during this operational period. For applying dynamic load balancing resource allocation in a self clocking manner, an operational period is defined in terms of the time it takes for the request arbitrator to process a fixed amount of requests, instead of a fixed real time duration.

Requested Resource Allocation—A weight or an equivalent percentage corresponding to a group of consumers, used to determine the ratio of how much resource a group of consumers would like to have, at a given time. It is the request arbitrator's decision to honor such requested resource allocation. It is also the request arbitrator's responsibility to try to match such requested resource allocation for all consumer groups.

Current Resource Allocation—The observed amount of resources allocated to a particular group of consumers in an operational period.

Actual Resource Allocation—A consumer group's resource allocation that takes into account historic data with emphasis placed on the most recently collected data. This is defined to be a consumer group's actual resource usage level.

Priority Scheme—A resource allocation scheme wherein resources are allocated according to a priority attribute. A higher priority corresponds to a higher chance for the requester for obtaining a particular resource, having more allocation of such resource, or having more timee on monopoliiing such resource. Requestors with the same priority may be served on a round robin basis or first come first served basis.

Strict Priority Scheme—A priority scheme wherein the request being serviced always has the highest priority.

Probabilistic Priority Scheme—A priority scheme wherein a higher priority task does not always get the priority over a lower priority task. However, the higher priority task may be guaranteed to have a higher chance of getting allocation (or more allocation in terms of duration or amount).

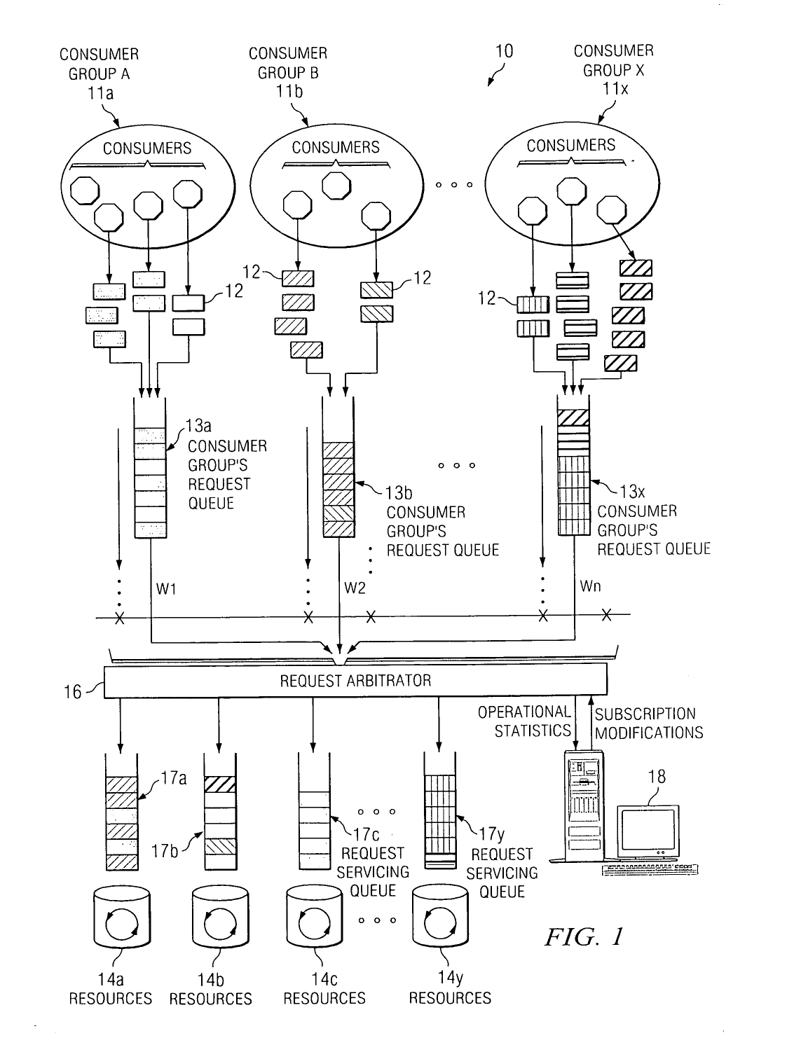

Referring now to the block diagram of FIG. 1. As shown, groups of consumers 10a, 10b, . . . 10x generate requests 12 to owners of network resources 14a, 14b, . . . 14y. Each request 12 is stored in a respective consumer group request queue 13a, 13b, . . . 13x. A request arbitrator 16 determines according to overall resource usage, observed resource allocations and request resource allocations how to service the requests from all the consumer groups 10. The request arbitrator 16 and the consumer groups request queues 13a thru 13x are typically implemented as drivers at a sending node of the network. If there is more than one resource available, the request arbitrator 16 determines how to make a fair use allocation of the available resources by measuring serviced requests. The request arbitrator 16 allocates the requests 12 to a respective request servicing queue 17a, 17b, . . . 17y, as will be further explained below. Each resource 14a. . . 14y receives requests from the corresponding request servicing queue 17, which is implemented with hardware at the resource. A user interface 18 is used to dynamically change consumer groups, available resources, and requested resource allocation. Furthermore, the user interface 1 8 can also be used as a reporting interface to present collected statistics.

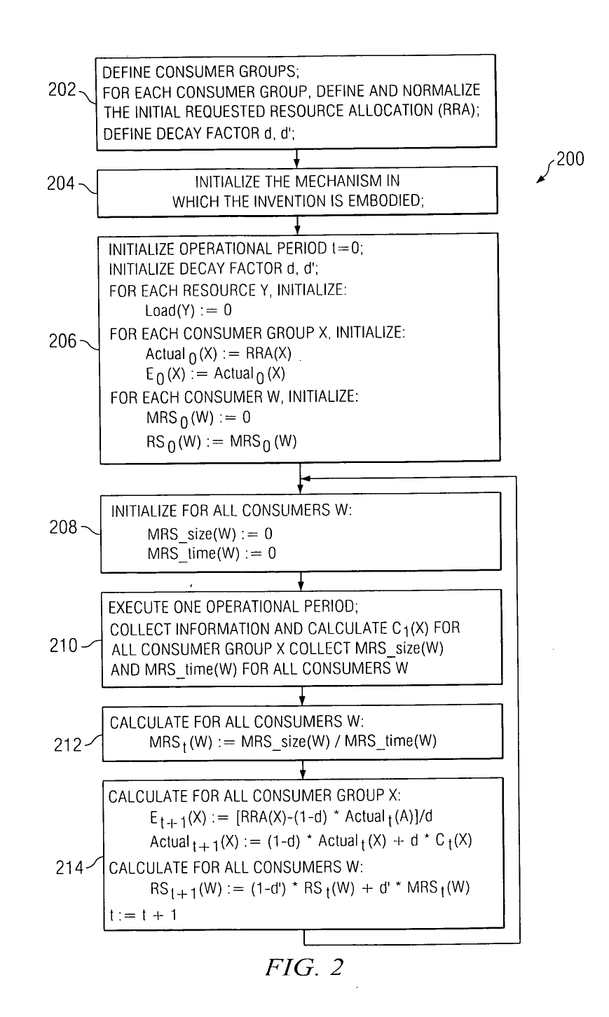

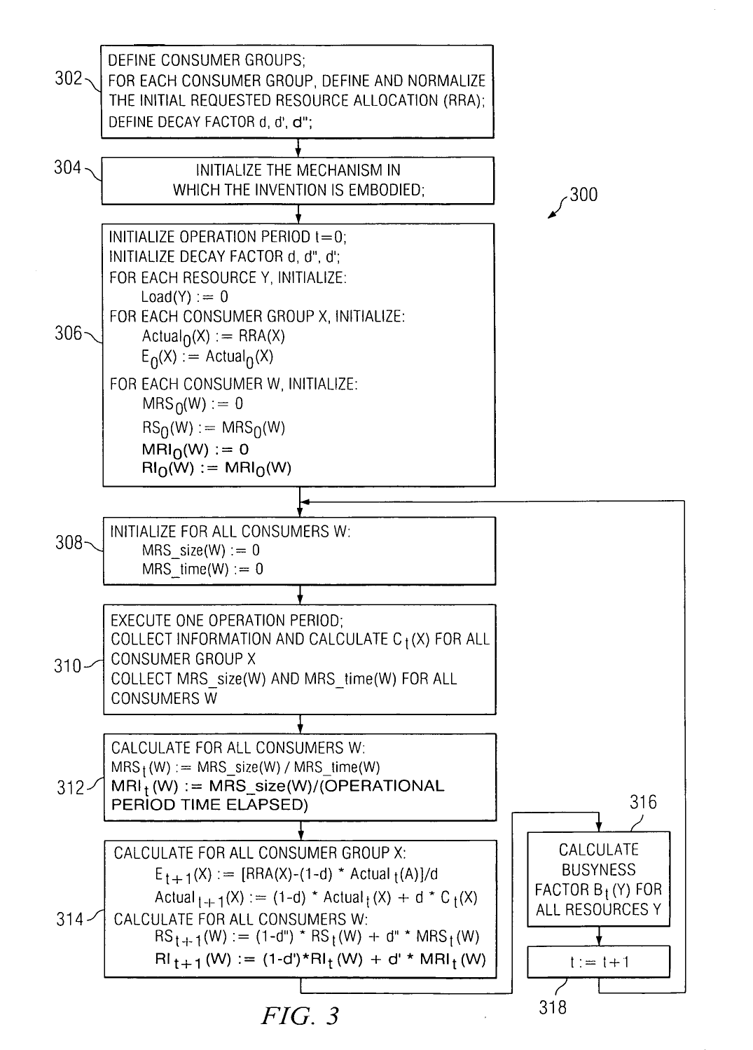

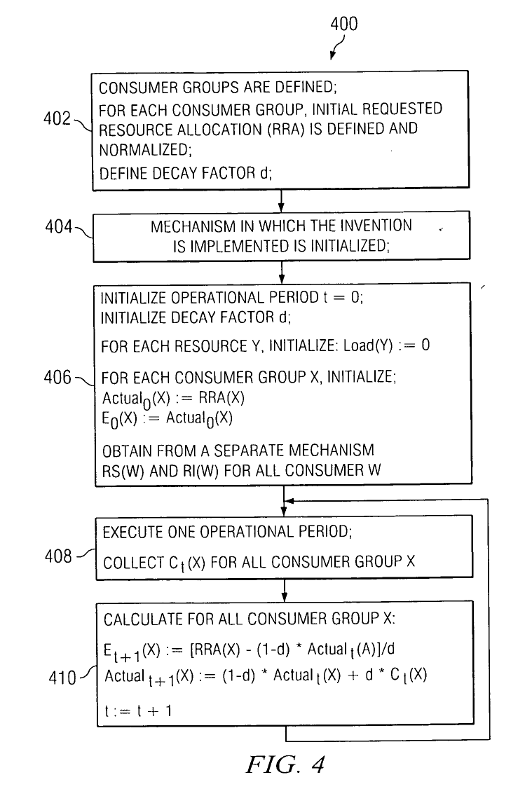

FIGS. 2, 3 and 4 are flowcharts showing variations of the manner in which the request arbitrator 16 allocates resources 14a, 14b, . . . 14y to consumer groups requests 12 generated by consumer groups 10a, 10b, . . . 10x. The process 200 shown in FIG. 2 is for applications without the restriction of consumer to resource binding, whereas the process 300 shown in FIG. 3 is for applications with a consumer to resource binding restriction. Such restriction is further detailed in the remaining part of the disclosure. FIG. 4 shows a variant embodiment, process 400, that is a simplified implementation of the resource allocation as described above. The performance characteristics of the consumers and resources are predetermined in the exemplary implementation. It is noted that the flowcharts of FIGS. 2, 3, and 4, are variants of the base method but are structurally similar to the base method. The base method is described below with occasional references to the variant implementations.

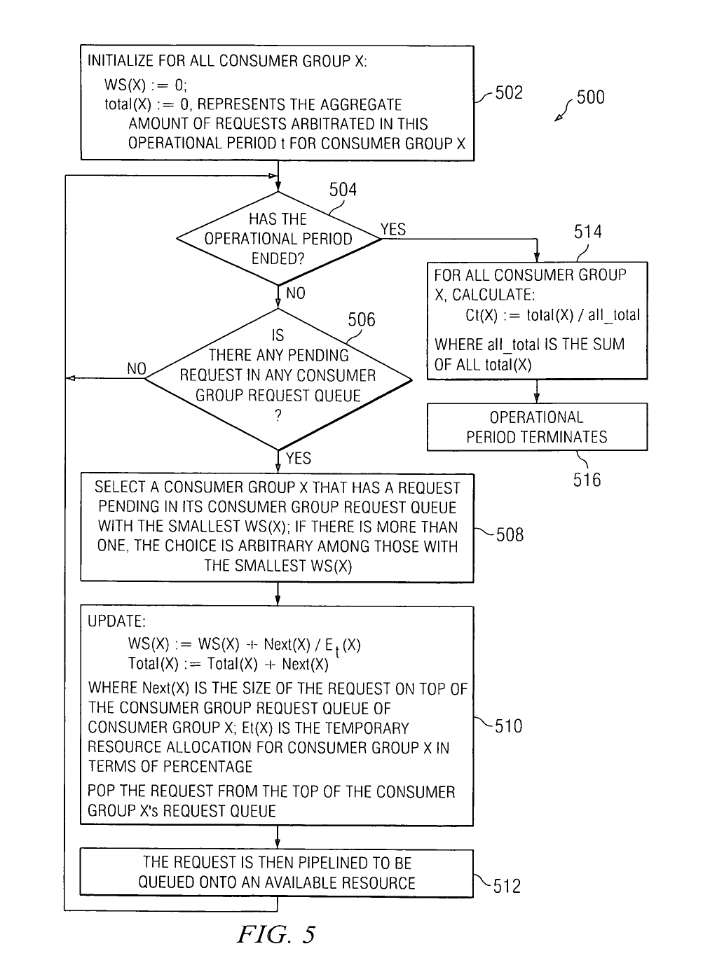

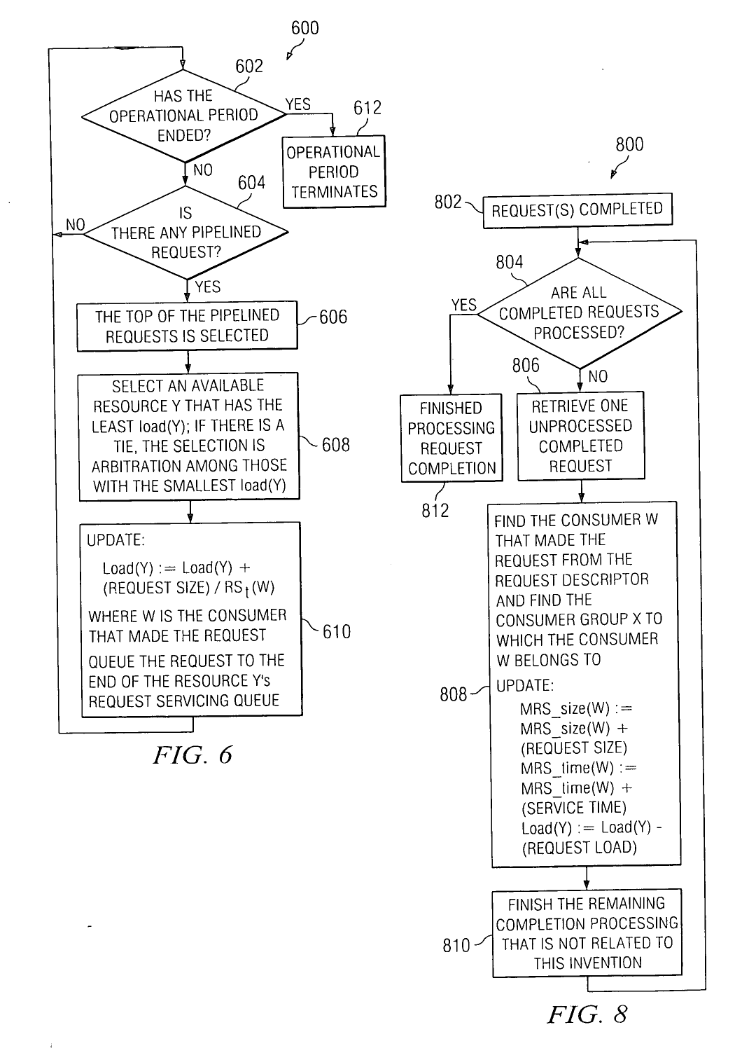

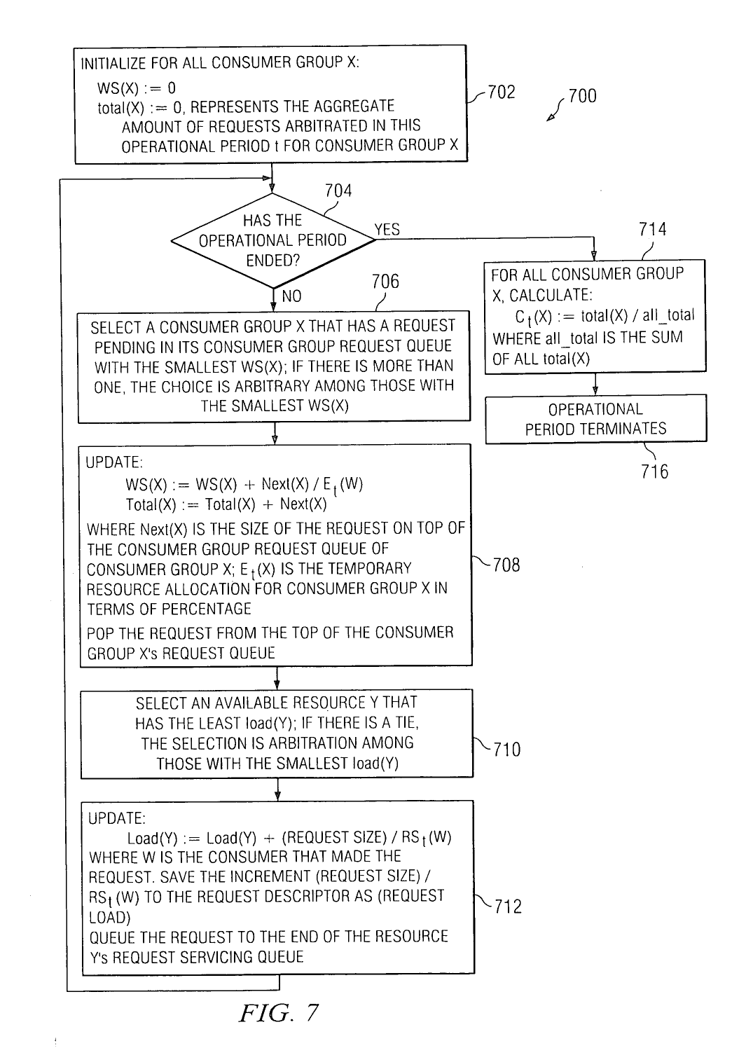

In each of the processes 200, 300 and 400, depicted in FIGS. 2, 3 and 4, respectively, there exists a shaded box step 210, 310 and 408 respectively. Each of these steps represents one operational period, which are further detailed ill subsequent flowcharts; more specifically, the processes 500, 600 and 700 shown in FIG. 5, 6 and 7, respectively. Process 500 and process 600 go together. They represent an asynchronous version of process 700. Process 500 represents a 1^{st} half of an operational period. Namely, process 500 illustrates how consumer requests pending on different consumer group request queues 13a, 13b, . . . 13x, are arbitrated by the request arbitrator 16. Process 600 represents the 2^{nd} half of the operational period in the process of FIGS. 2-4. Namely, process 600 illustrates how the request arbitrator distributes requests to different request servicing queues 17a, 17b, . . . 17y. Thus, FIGS. 5 and 6 show how these two different but related process parts can be separately done Process 700 shows a combined version, which is coined as the ‘synchronous’ version. It shows how the two parts are used together. The discussion that follows focuses on the combined version process 700 as illustrated in FIG. 7. Then, FIG. 8 shows how the completions of requests are processed, which will be also explained in latter part of this disclosure.

Now referring back to process 200, in step 202, a desired consumer trouping is determined. The allocation of resource usage for each consumer group is chosen by the client. This desired allocation is Request Resource Allocation (RRA). The following example is for three groups of consumers A, B and C. However, it will be evident that the number of consumers does not need to be limited. Typically, x %, y % and z % of the available resources are allocated between consumer groups A, B, and C respectively such that x %+y %+z %=100%. The percentages x %, y %, and z % may be specified in terms of: 1) percentages of desired resource allocation of the total available resource at a time for the corresponding group, or 2) a weight factor used to determine the percentages of desired resource allocation of the total available resource at a time for such colresponding group. The first approach (1) is used for specifying the requested resource allocation parameters. However, a normalization step may be required to bring the summation of all input parameters equal to one. For example,
x′=x/(x+y+z)
y′=y/(x+y+z)
z′=z/(x+y+z)

For convenience, the weighting/percentages might be rounded off to integers. Rounding off floating point numbers in the normalization calculation might result in the resulting sum not being equal to 100%. In such case, any minor modification to the weights/percenitages might be preformed (although its details are beyond the scope of this description).

In some instances, it may not be possible to physically realize an allocation even though the client has requested that allocation in step 202. For example, it is possible that when the requested resource allocation is specified, it is not possible to predict the outcome from the other consumers. Furthermore, consumers might have varying behavior and the availability of resources might change. Additionally, consumers might come and go consequently affecting the overall usage pattern. It is also possible that consumers do not use as much of the resource as they requested.

As can be seen, there will be a difference between the requested resource allocation and the actual usage of the resource (i.e., the actual resource allocation). For each group of consumers, a relationship between the requested resource allocation and the actual resource allocation can be defined. Namely, a consumer group's actual resource allocation (in percentage) at a given time (i.e., Actualₜ(group)) is defined using the following decay function (in process 200; more specifically, in step 214).
Actualₜ(group)=(l-d)*Actualₜ₋₁(group)+d*Cₜ(group)
The argument d specifies the rate of decay of the old actual resource allocation data in percentage terms. Such attribute can be specified and/or defaulted to be certain values in initialization or changed on the fly. For example, d can be 50%, which meanis that the actual resource allocation depends 50% on the newly collected data and 50% on historic actual r1esource allocation values. Note that the decay of the resource usage of a particular historical period is a geometric progression with a factor of d. In process 200, this decay factor is defined in 202, along with other decay factors described later. This is done right before the initialization process of the mechanisim in which the dynamic resource allocation algorithm is implemented, as indicated in step 204.

The actual resource allocation is expressed in the form of a decay function to stress the importance of the latest resource usage and at the same time take into account the historic data. A high decay ratio ignores historic data. A decay ratio of 100% would make the resource allocation behave as a weighted round robing scheme. Alternatively a low decay ratio would average out the resource usage more than a high decay ratio does and in turn would cause the overall resource usage in an extended period of time to be very close to the requested allocation. This can be used to smooth out the burstiness of request patterns. The actual resource allocation for each consumer group is initialized in step 206 to the request source allocation, RRA(X), of the corresponding consumer group X, along with other working variables used in this process. It is noted that these actual resource allocations are updated at the end of each operational period as shown in FIG. 2, step 214.

As used in this context, the term C₁ is a consumer group's real resource allocation percentage in the most current completed operational period (i.e., the observed allocation in the completed operational period t). The term C₁(group) is obtained by recording the number of requests processed for that group in the operational period t. The term t specifies a monotonic increasing sequencing of time in terms of the number of operational periods. As depicted in FIG. 2, step 210, C₁(X) value is calculated at the end of each operational period.

It is noted that in step 210 of process 200, requests are selected for being served based upon an arbitration policy and the temporary resource allocation determined in step 206 for the initial values or step 214 (from the previous loop) for subsequent values. Process 700 depicts such operational period in details. The arbitration policy is similar to a weighted round robin scheme. A simple round robin scheme gives equal shares of resources to each consumer whereas a weighted round robin distributes resources according to weighting factors, i.e., E₁(group). At the end of each operational period, the weighing used in the weighted around robin scheme is changed according to the temporary resource allocation determined in step 214.

The operational period can be defined in a self-clocking manner instead of a Fixed period of time. The operational period can be defined as the time for processing x number of requests or x amount of data. With self clocking, the operational period is shorter when there are more requests for the shared resources. Similarly, when there are fewer requests, the operational period becomes longer. The operational period should be long enough so that any calculations involved in arbitrating requests would not become a significant overhead. Various implementations of the process define what an acceptable level of overhead is according to the requirements of such implementations. Furthermore, the operational period should be small enough such that variation in different operational periods would not be perceived and cause significant variations in the perceived behaviors of clients. The operational period should also be small enough Such that the burstiness of requests doesn't cause a sudden monopolization of resources.

As shown in process 200, a temporary resource allocation, E₁(X), for the next operational period is calculated for each consumer group X, in step 214. Assume for example that the calculated actual resource allocations from step 214 at time t are 35%, 35%, and 30%, respectively, for group A, B, and C. Assume also that the desired resource allocations fiom step 202 are 50%, 30%, and 20%, respectively, for groups A, B and C. In this case, the resource allocations should be changed in order to reach the desired allocations. For a consumlier group that has an actual allocation less than the requested allocation, its temporary resource allocation, Eₜ(X), in the next operational period should be bumped up so that the projected actual allocation is (at or closer to) the requested amount. This is performed by allowing, in the next operational period, more allocations than the actual allocation to this group. Similarly, a group that exceeds its allocation will have its temporary resource allocation reduced Such that the projected actual allocation is lowered to the requested amount.

In step 214, a temporary resource allocation for the next operational period is found such that the projected actual resource allocation in operational period t+1 is as close to the requested resource allocation as possible. For example, in group A, an estimated Cₜ₊₁(A), i.e., Eₜ₊₁(A), is calculated such that the Actualₜ₊₁(A) is projected to reach the requested resource allocation percentage in the next operational period. Namely, the next Actual(A), i.e., Actualₜ₊₁(A), should be substantially the same as the requested resource allocation of group A, i.e., 50%:
Actualₜ₊₁(A)=50%=(1−d)*Actual₁(A)+d*Eₜ₊₁,(A)
i.e., the suggested Eₜ₊₁(A)=[50%−(1−d)*Actualₜ(A)]/d
The general formula is:
Eₜ₊₁(A)=[RRA(A)−(1−d)*Actualₜ(A)]/d
Where RRA(A) is the requested resource allocation of group A. This calculation is shown in the step 214 of process 200. It is noted that at the beginning of the first operational period t=0, and Eₜ(X) are all initialized to Actualₜ(X) as shown in step 206.
Example: If d is 50%; Actualₜ(A) is 35%, Actualₜ(B) is 20% and Actualₜ(C) is 45%; RRA(A)=50%, RRA(B)=30% and RRA(C)=20%:
Eₜ₊₁(A)=[50%−(1−50%)* 35%]/50%=65%
Eₜ₊₁(B)=[30%−(1−50%)* 20%]/50%=40%
Eₜ₊₁(C)=[20%−(1−50%)* 45%]/50%=5%

Therefore, in the next operational period, 65% of the resources are allocated to group A, 40% of the resources are allocated to group B, and 5% of the resources are allocated to group C, in order to bring the actual resource allocations back to their corresponding requested resource allocation.

Notice that Eₜ₊₁(X) should be at least 0% by definition, as it is a projected observed resource usage allocation. However, depending on the decay factor, requested resource allocation and the actual resource usage pattern, Eₜ₊₁(A) might be projected to have a negative number. Accordingly, even if in the next round no resource is allocated to such group, its actual resource allocation is still bigger than its requested resource allocation. In such case, a minimal allocation is assigned so that the group can at least get a minimal resource allocation, say 1% Furthermire, an extra normalization process of the resulting Eₜ₊₁(X) would be needed (normalization of the Eₜ₊₁(X) values so that their simi is 100%).

Notice also that Eₜ₊₁(A) is an estimate for the desired Cₜ₊₁(A). However, Cₜ₊₁(A) might be very different from Eₜ₊₁(A), as the actual number depends on how the requests conie in the next operational period.

Now, referring back to process 700, in which we determine which group's head-of-the-queue request is to be serviced next by the request arbitrator 16. To that end, the weighited Suml (WS) values of serviced requests of the groups are compared in the current operational period in step 706. The weighted sumn of serviced requests of a group is determined by the total amount of requests that have been processed in Such operational period t, divided by Eₜ(group) (in percentage or in weight). All weighted sum values are initialized to zero at the beginning of each operational period as shown in step 702 of process 700. The group that has the least sum will have the highest priority to be picked and serviced. If there are at least two minimal weighted sum values, the arbitration among the groups corresponding to these minimal WS values is arbitrary. It is only necessary to arbitrate among those groups with outstanding requests. Temporary resource allocation that has been allocated to a group and is not fully utilized can be used by other groups. The selection logic distinguishes between the next group to service and the remaining groups that are waiting to be serviced, without much look ahead in other bookkeeping data structures.

Suppose at the start of an operational period, Eₜ(group) for the previous operational period was calculated as follows: Eₜ(A)=65%, Eₜ(B)=40% and Eₜ(C)=5%. The weighted sum of requests of each group at the begininiig of an operational period is zero, that is, WSₜ(A)=WSₜ(B)=WSₜ(C)=0, as shown in step 702 of process 700.

The following table expresses a possible sequence of events happening at the beginning, of such operational period. Next(X) represents the size of the request at the top of the consumer group X's request queue (The latter part of process 700, steps 710 and 712 are explained in subsequent discussions):

| WS(A) | WS(B) | WS(C) | Next(A) | Next(B) | Next(C) | Note |
|---|---|---|---|---|---|---|
| 0 | 0 | 0 | 100 | 400 | 10 | Request from A is picked |
| | | | | | | because W(A) is among the |
| | | | | | | smallest (step 706) |
| 154 | 0 | 0 | 200 | 400 | 10 | As Eₜ(A) = 0.65 → |
| | | | | | | 154 = 0 + 100/0.65; (step 708) |
| | | | | | | Next(A) becomes 200 (arbitrary, |
| | | | | | | depends on what shows up); |
| | | | | | | Request from B is then picked |
| 154 | 1000 | 0 | 200 | 10 | 10 | 1000 = 0 + 400/0.4; |
| | | | | | | Next(B) becomes 10 (arbitrary); |
| | | | | | | Request from C is then picked |
| 154 | 1000 | 200 | 200 | 10 | 150 | 200 = 0 + 10/0.05; |
| | | | | | | Next(C) becomes 150 (arbitrary); |
| | | | | | | As WS(A) becomes the smallest |
| | | | | | | once again, A is then picked |
| 462 | 1000 | 200 | 600 | 10 | 150 | 462 = 154 + 200/0.65; |
| | | | | | | Next(A) becomes 600 (arbitrary); |
| | | | | | | C is picked next |
| 462 | 1000 | 3200 | 600 | 10 | 70 | A is picked |
| 1385 | 1000 | 3200 | 24 | 10 | 70 | B is picked |
| . | . | . | . | . | . | . |
| . | . | . | . | . | . | . |
| . | . | . | . | . | . | . |

With this arbitration policy, the total amount of requests serviced for each group would be approximately equal to the amount specified by the product of Eₜ(group) times the total amount of requests serviced at a given time in the operational period. The approximation is statistically more accurate towards the end of the operational period, especially when the arbitrator is provided with a continuous supply of consumer requests from each of the groups A, B and C.

If the supply of consumer requests is not continuous, the arbitration process can be illustrated by the following hypothetical example:

| WS(A) | WS(B) | WS(C) | Next(A) | Next(B) | Next(C) | Note |
|---|---|---|---|---|---|---|
| . | . | . | . | . | . | . |
| . | . | . | . | . | . | . |
| . | . | . | . | . | . | . |
| 22460 | 22221 | 23400 | 300 | n/a | 400 | A is picked even though WS(B) |
| | | | | | | has the smallest value |
| 22922 | 22221 | 23400 | 600 | n/a | 400 | 22922 = 22460 + 300/0.65 |

Comparisons are only made among groups with active requests outstanding. The calculation of the weighted sum of requests remain the same as the parameters, more specifically the ratio Eₜ(group)'s used in the calculation, remain the same.

Within an operational period, in order to avoid allowing a particular consumer- group to suddenly gain more access to the resources simply because it hasn't had any request outstanding recently (i.e., the requests are bursty), the weighted sum may decay periodically with a simple decay function. Such decaying interval may be defined in real time or in a self clocking way as a fraction of the operational period. In the former approach, the period should be a small duration relative to the operational period statistically. For example, if on the average the self clocking operational period is in the range of1 to 5 minutes, such decaying interval may be defined to be 10 seconds. In case the operational period becomes less than the decaying interval because of high traffic rate, the operational period just ends without doing any weight decaying calculation. In both approaches, each WS(X) is allowed to decay to a smaller number periodically to minimize the accumulation of too many credits of a consumer group due to its prolonged inactivity. The same effect can also be achieved by having a shorter operational period.

Depending on the actual application, there might be additional restrictions applied onto the way the consumer requests are serviced. For example, if there is a need to maintain a strict ordering for the requests coming from the same consumer (such ordering is maintained until a request is completely serviced), the request arbitrator 16 might need to queue requests coming from the same consumer to the same resource or resource producers. Additional logic would be needed to perform the required restrictions and load balancing.

This restriction causes the differences in the embodiments as shown in process 200 of FIG. 2 and process 300 of FIG. 3. The differences are highlighted in bold in the flowcharts. In case such consumer and resource bindings exist, one has to 1) create additional decay factor d′, as shown in step 302, for the request incoming rate, 2) do the RI(W) calculation as shown in step 314, 3) obtain the measured request incoming rate MRI(W) for each consumer W, as shown in step 306 and 312, and 4) calculate the busyness factors in step 316 with these additional variables. If Such restriction does not exist, there is no need to maintain these additional variables and there is no need to calculate busyness factors for the resources. That is, as is the case on the exemplary process 200 of FIG. 2, there is no need to perform the calculation steps.

If a resource or a resource producer is viewed as a component composed of a queue of requests to be serviced plus a servicing logic, in order to maintaining strict ordering of requests coming from the same consumer, the request arbitrator 16 needs to keep track of the binding between the consumers and the resources. Such binding can be realized in the form of a table like data structure accessible by the request arbitrator 1 6. Only when the request servicing queue doesn't contain any outstanding request for a consumer can the request arbitrator 16 change the binding between a consumer and the existing resource to a different one (i.e., break the existing consumer to resource binding and re-establish a new one).

Alternatively, a request arbitrator 16 may be completion interrupt driven. In this example, a completion interrupt refers to the interrupt given to the arbitrator 16 when a request servicing queue, one of the 17a, 1 7b, . . . 17y, has become empty. Within the arbitrator, each data structure representing a resource or resource producer is marked with an indicator showing whether the corresponding resource has any requests pending in the request servicing queue. If there are none and the request arbitrator 16 processes a consumer request for that particular resource, the arbitrator 16 queues such request to the corresponding request servicing( queue. In the same processing, using the consumers to resources binding table, the arbitrator 16 may also find consumers that are bound to such resource and search in those corresponding consumer group request queues for all matching consumer requests that can be queued on the same request servicing queue and prepare them for being serviced. It then queues a completion interrupt at the end of the queue so that such interrupt can be given when all the requests in the request servicing queued are serviced and the queue becomes empty again. If on the other hand, there are requests outstanding on the request servicing queue, then the new incoming requests would stay in its consumer regroup request queue, and wait for the pending requests to be serviced and the request queue to become emptied, before getting queued onto the corresponding request servicing queue. Upon the reception of a request servicing queue's completion interrupt, the request arbitrator 16 searches for all, or depending on available buffering resources, LIP to a certain amount of, consumer requests that have the correct binding, queues them onto the request servicing queue and terminates the queue with a completion interrupt. The arbitrator either queues all the submitted consumer requests or queues the requests until the request servicing queue is full. With such approach, the arbitrator 16 only needs to keep track of the consumers to resources binding but doesn't need to know whether a certain consumer has outstanding requests queued on a request servicing queue or not. As a result, whenever the arbitrator 16 is processing a completion interrupt, it can break the corresponding existing consumer to resource bindings and re-establish new ones if needed.

In addition to the foregoing, the request arbitrator 16 calculates the consumer load for each consumer in consumer group 10a, the consumer load for each consumer in consumer group 10b, and so on, thru 10x, in various steps of process 200 and process 700. For each consumer in each Consumer group 10, the request arbitrator 16 calculates the load in terms of the rate of incoming requests per second, denoted as RI(x) and the rate a unit of resource can service such type of request, in terms of unit request per second, denoted as RS(x). A unit request can be a byte, a fixed sized packet, or a fixed cost requests.

Under the restriction of having consumers to resource bindings, due to the differences between consumers and the need of achieving proper load balancing, it is required to determine the rate of servicing per unit of resource, ie., RSₜ(W), for each consumer W. The load a consumer delivers to a particular resource is directly translated to the load its requests put onto the resource if at a time a consumer can only be bound to a single resource. All requests generated by a consumer are assumed to possess similar characteristics. The quality of load a consumer puts onto a resource is expressed in terms of the average time duration a unit request spends on being serviced by Such resource Typically, in the long run, consumer requests should be processed at a faster rate than the incoming rate of Such requests or more and more consumer requests would be accumulated at the consumer group request queues.

The incoming request rate of a consumer is limited by how fast the request arbitrator 16 picks up requests from the corresponding consumer group's request queue. Hence, from the view point of the request arbitrator 16, the incoming request rate of a particular group of consumers cannot exceed the rate the resource producers service the requests. The incoming request rate of a particular consumer depends on how the request arbitrator 16 processes the incoming requests, which in turns is affected by the incoming request pattern of all the consumers.

Requests from a consumer might be coming in at a faster rate than the processing speed of all the available resources. Moreover, various groups of consumers are also competing for resource allocations. If every croup is contending the resource, the incoming rate of a consumer's requests is limited roughly by the requested resource allocation. On the other hand, if these factors don't serve as limiting factors, the incoming request rate of a consumer is purely determined by how fast the consumer submits the requests.

In addition to determining the rate of servicing for each consumer per unit of resource, in order to determine the consumer's load on a unit of resource, one has to calculate the incoming request rate of such consumer. The incoming request rate of a consumer is actually measured. A decay function is applied to the collected historical data. For example, let x be a consumer such that the incoming request rate of such consumer x in an operational period t, i.e., RIₜ(x), is calculated as:
RIₒ(x)=MRI₀(x); where MRI represents the measured incoming request rate for a given operational period
RIₜ(x)=(1−d′)*RIₜ₋₁(x)+d′*MRIₜ(x)
MRIₜ(x) is the measured incoming request rate in the operational period t. To obtain this number, in an operational period, the arbitrator 16 maintains for such consumer the unit amount of requests it has processed, and divides that amount by the processing time elapsed. Referring back to process 300 in FIG. 3, MRI is calculated in step 312 with the help of the variable MRS_size initialized in step 308. The operational period time elapsed in step 312 is simply the time elapsed it takes to execute the shaded box, step 310. This operation might require additional hardware support. MRIₜ(x) and RIₜ(x) are expressed in terms of unit amount per second. The decay factor d′ specifies the decay rate of the historic data. This decay factor may be defined to be dependent on the variance of the incoming request rate of the consumer and different for different consumers. However, a configurable fixed decay factor can still serve the purpose of taking historic data into account yet stressing the importance on the most recently collected data. To simplify an implementation, one uses the same decay factor on all consumers. Depending on the application, such incoming request rate of consumers may be predetermined or calculated in sparse intervals if the rates are expected to remain pretty much constant. For example, such calculation can be done once every 20^{th} operational periods.

The rate of servicing is defined in a very similar way. The servicing rate for the requests of a consumer x in the operational period t is defined as:
RS₀(x)=MRS₀(x)
RSₜ(x)=(1−d″)*RSₜ₋₁(x)+d″*MRSₜ(x)
d″ is a decay factor similar to d′. MRSₜ(x) is the measured servicing rate. Referring back to the process 300 in FIG. 3, the calculation of MRS is done in step 312, whereas the calculations of RSs are in step 314.

These calculations rely on two additional variables called MRS_size and MRS_time, which are initialized in step 308 of process 300. These variables are updated when the completion of requests are processed. An example of tile processing of request completion is depicted in FIG. 8. MRS_size and MRS_time are updated in step 808 of process 800.

Similar to the calculation of MRIₜ(x), implementation for calculating MRSₜ(x) can be separate from the implementation of this invention. MRIₜ(x) can be much more varying than MRSₜ(x) as the former depends solely on the request pattern of a consumer which can fluctuate without a real pattern, and the latter depends solely on the consumer request characteristics. Such factors in turns depend on non-changing network attributes such as distance between the sender and receiver, the efficiency of the send engine and that of tile remote receive engine, etc.

If such rate has to be determined in real time, an implementation might need help from a separated logic/protocol in the service agent to time how long it takes to service a request. As mentioned before, this might require hardware support from the sending ASIC. For example, the send engine of a node participating in a reliable link protocol may provide a feature to timestamp tile request descriptor data structure when different operation is being done on such descriptor. More particularly, it may put a timestamp on a request descriptor when it starts to service such request and put a timestamp on the same descriptor when the servicing is done (e.g., upon the reception of the last acknowledgement). The request arbitrator then collects and calculates the MRSₜ(x) based on those data.

For implementation with service agents/resource producers lacking such timestamp feature, such implementation might resort to a separated mechanism to measure such servicing rate. As mentioned before, if MRSₜ(x) doesn't change often, an implementation can rely on pre-determined values. Notice that depending on the application, an exact measurement of the rates may not be needed as long as the request arbitrator 16 can use that data to do a fair comparison between different resources. Process 400 depicted in FIG. 4 shows an embodiment using predetermined RS and RI for each consumer. Process 400 is basically a simplified process from process 200 or process 300.

Now referring to the non-degenerated cases, that are process 200 and process 300, the estimated relative load a consumer x puts out in operational period t is defined as:
RIₜ(x)/RSₜ(x)
This number is used in the next operational period to determine the load a consumer puts onto its corresponding resource(s). It is a relative load as it is used to compare against other similarly calculated numbers.

A busyness factor is associated with each resource 14a, 14b, . . . 14y. The busyness factor of a resource is the sum of all the loads its associated consumers put onto it. In process 200, Such busyness factors do not need to be explicitly calculated, whereas in process 300, busyness factor of each resource is calculated at the end of each operational period.

For applications that don't have additional restrictions like the one depicted in process 200 (i.e., the consumers to resource binding), requests can be assigned to whatever available resource the request arbitrator 1 6 can choose. II Such case, tile busyness factor of a resource is basically the weighted sum of all the works pending on its request servicing queue. In other words, the busyness of a resource is the sum of the normalized cost of all pending requests. The normalized cost associated with a request is calculated by dividing the unit cost Of Such request by the corresponding consumer x's RSₜ(x). The unit of the calculation result doesn't matter unless the data has to be presented in a human readable form, as they are used for making comparison of busyness among resources only. In short the busyness factor is:
Σ[(cost of request in terms of unit amount)/RSₜ(consumer that produced the request)]

To distribute the consumer loads evenly to the available resources, the arbitrator always assigns the next request to the resource that has the least load. This is depicted in step 710 of process 700. The following table illustrates Such arbitration. Suppose there are four available resources and they start out with the loads specified on the first row of the table:

| | | | | Servicing | | |
|---|---|---|---|---|---|---|
| | | | | cost of | | |
| Resource | Resource | Resource | Resource | Next | | |
| 1's load | 2' load | 3's load | 4's load | Request | RSₜ(Next) | Note |
| 3947 | 4684 | 3742 | 3648 | 3600 | 3 | This request is assigned |
| | | | | | | to the fourth resource |
| 3947 | 4684 | 3742 | 4848 | 6748 | 6 | 3648 + 3600/3 = 4848; |
| | | | | | | The next request is |
| | | | | | | assigned to the 3^{rd} |
| | | | | | | resource |
| 3947 | 4684 | 4867 | 4848 | 346 | 5 | 3742 + 6748/6 = 4867; |
| | | | | | | The next request is |
| | | | | | | assigned to the 1^{st} |
| | | | | | | resource |
| 4016 | 4684 | 4867 | 4848 | . . . | . . . | . . . |

Loads are taken off upon the completion of the service by similar calculation but with the addition replaced by a subtraction. Such calculation is done in step 808 of process 800, when the completion of requests is processed. In this way, the busyness of a resource is calculated while the request arbitrator 16 is processing the requests and upon the completion of requests. Hence, there is no equivalent step 316 as in process 300 in process 200.

If there are additional constraints such as the aforementioned consumer to resource binding process 300, then the algorithm averages out the predicted consumer loads, instead of the consumer loads, on the available resources. In such case, the amount of existing work outstanding in the request servicing queue doesn't give a sufficient indication of the upcoming work. A consumer x's request load has to be estimated using the incoming request rate RIₜ(x). The busyness of a resource y is then defined as:
Bₜ(y)=ΣRIₜ(x)/RSₜ(x)]
The summation is for all consumer x's bound to the same resource y. [n this way, the busyness of a resource is not calculated as the request arbitrator 16 processes each request but at the time when the algorithm calculates RIₜ(x) and RSₜ(x), which happens between two operational periods, as shown in step 316 of process 300.

Given a request, the arbitrator finds the consumer- that generates Such request. By looking up the consumer to resource binding table, the arbitrator then finds the resource corresponding to such consumer. It then queues the request to the request servicing queue corresponding to Such resource. This is also explained as a side note in process 600 and process 700 in FIG. 6 and FIG. 7 respectively.

Rearrangement of consumer-to-resource binding is done in the order such that the consumer with more expected load is re-distributed first. Such ordering allows the loads to be more evenly distributed among resources, as the later the binding, the finer tuning it is doing to previously done coarser bindings.

If there is no specific consumer to resource binding, the load balancing is automatically achieved. The request arbitrator always selects the least busy resource to service the next incoming request.

If there is consumer to resource binding restriction, the load balancing is performed when the restriction can be removed (i.e., binding removed). More particularly, if, for example, a consumer needs to preserve the ordering of the servicing of its requests, the request arbitrator 1 6 can only queue its requests to a particular request servicing queue. Such binding is removed when there is no request of such consumer outstanding in such request servicing queue. At that point, a consumer can be assigned to a different resource next time when a new incoming request shows up. Such consumer should be bound to the least busy resource, that is, the resource Y with the smallest Bₜ(Y). If there is a tie, the selection is arbitrary among those with the smallest Bₜ(Y). A mapping or binding table used to keep track of the binding of consumer and resource indicates whether a consumer request should be queued to a bound request servicing queue or the request servicing queue of the least busy resource. II the latter case, the new binding is established. Such assignments should result in evenly distributing loads among all available resources.

The variance of the request incoming rate of a consumer may be taken into account to determine how Such consumers should be bound to a particular resource. For example, a sudden burst of load on a particular resource may be avoided by spreading out high cost, high variance requests across all resources.

An operational period is terminated immediately if there is any modification to any of tile following:
1. Number of consumer groups; subtraction or addition.
2. Weighing factors corresponding to a consumer group.
3. Resource availability (E.g., number of available resources, efficiency of resources, etc.)

Upon such termination, an appropriate data structure is added or deleted from the working data structures. Only the request arbitration process is restarted from scratch. Requests that have been queued will be retained in the request servicing queue pending for service. The existing consumer to resource bindings are preserved if there is any. The statistics of existing consumers are preserved. The statistics of existing resources are preserved. The statistics of the existing consumer groups, such as the temporary request allocations and actual request allocations, are rebuilt from scratch. The addition or deletion of a consumer group doesn't alter how the requests arbitrator 16 operates other than letting it to have a different number of consumer groups available for arbitration.

If a resource is taken out temporarily for transient errors or permanently for unrecoverable errors, the consumer requests pending on its corresponding queue need to be redistributed to other available resources. Such operation is similar to the load balancing procedure described previously.

The user interface 18 can be built on top of an implementation to allow a client to define consumer groups and do adjustments to each group's weighing factor. By having the flexibility of defining consumer groups and the associated weighing factor in a non-restrictive way, a client can effectively utilize such controls collectively as a way to specify the quality of services given to groups of consumers. An implementation allows a client to dynamically add or delete groups and modify any existing group's associated weighing factor, while the resources are being used in an uninterrupted fashion. It also allows dynamic modification to the amount of resources with minimal and transparent disruption only to involved parties.

Furthermore, statistical data can be presented to a client through programmatic interface or user interface 18 on demand or periodically. Such data provides information oil how the resources are utilized and how different consumers believe at different times. For example, a user interface can display for all consumers in a group the corresponding RI_{current}_{_{—}}ₜ(x) and RSC_{current}_{_{—}}ₜ(x). The former data shows how much load is given by a consumer and the latter gives an idea of how effective consumer requests are being handled. The data for a consumer group can also be coalesced into a more concise format. For example, a consumer group's rate of servicing can be presented. Historic data can be collected and saved for further analysis of resource usage pattern.

Accordingly, it is intended that the embodiments shown and described be considered as exemplary only. The scope of claimed invention is indicated by tile following claims and equivalents.

1. A method for dynamic load balancing resource allocation, comprising;
receiving a desired allocation of resources for servicing a plurality of consumer groups requests;
determining an actual allocation of the resources for a present operational period;
determining a temporary allocation of the resources for a next operational period relative to the desired allocation and the actual allocation;
allocating the resources to the consumer group requests in the next operational period according to the temporary allocation; and
selecting consumer group requests to be serviced by the resources based upon availability of tile consumer groups requests and the amount of consumer groups requests being presently serviced.

2. A method as in claim 1, further comprising:
calculating a consumer load for each consumer group in response to tile number of consumer groups requests being serviced, wherein each consumer group request is associated with a consumer group;
calculating a busyness factor for each resource in response to tile number of requests being serviced; and
selecting the least busy resource to service tile consumer group requests based on the consumer load and the busyness factor.

3. A method as in claim 1 wherein the actual resource allocation of consumer group requests is expressed in terms of a weight factor or in terms of a percentage.

4. A method as in claim 1 further comprising:
normalizing a sum of all resource allocations to one (1.0).

5. A method as in claim 1 wherein the actual resource allocation is defined in terms of a decay function of a factored sum of a measured current resource allocation percentage and an actual resource allocation value from a previous operational period.

6. A method as in claim 1 wherein the operational period is self-clocking or is a fixed time period.

7. A method as in claim 1 wherein the next operational period is adjusted[ inversely to a number of consumer group requests.

8. A method as in claim 1 wherein the temporary allocation is expressed in terms of a requested resource allocation percentage, a rate of decay and an actual resource allocation percentage from a previous time period.

9. A method as in claim 1 wherein a priority for allocating the resources in the next operational period is determined using a weighted round robin scheme based on the temporary resource allocation percentage.

10. A method as in claim 9 wherein each consumer group request is associated with a consumer- group, and wherein tile weighted round robin scheme involves comparison of a weighted sum of serviced requests for each consumer- group.

11. A method as in claim 10 wherein the consumer group with a lowest weighted sum is given the highest priority

12. A method as in claim 10 wherein the weighted sum comparison is made only among consumer groups with active requests outstanding.

13. A method as in claim 10 wherein a decay function is used with tile weighted sum to minimize effects of an accumulated skewed request pattern.

14. A method as in claim 1 wherein the next operational period is shortened to minimize effects of an accumulated skewed request pattern.

15. A method as in claim 1 wherein restrictions are applied to servicing the consumer requests.

16. A method as in claim 2 wherein the calculation of the consumer group load for each group in a given operational period is based on a decay function of measured incoming; request rate.

17. A method as in claim 16 wherein the measured incoming request rate is based on the ratio of the requests processed over the given operational period for a particular resource.

18. A method as in claim 2 wherein the busyness factor for a particular resource is based on a sum of all consumers loads on the particular resource.

19. A method as in claim 2 wherein each consumer group load is defined, for a given operational period, as a ratio of incoming consumer group requests divided by the serviced requests for a particular resource.

20. A computer readable medium embodying a computer program with code for dynamic load balancing resource allocation, comprising;
code for causing a computer to determine an actual allocation of the resources for a present operational period;
code for causing the computer to determine a temporary allocation of the resources for a next operational period relative to the desired allocation and the actual allocation;
code for causing the computer to allocate tile resources to tile consumer group requests in the next operational period according to the temporary allocation; and
code for causing the computer to select consumer group requests to be serviced by the resources based upon the amount of requests being presently serviced.

21. A computer readable medium as in claim 20 further comprising:
code means for causing tile computer to calculate a consumer load for each consumer group in response to the number of consumer groups requests being serviced, wherein each consumer group request is associated with a consumer group;
code means for causing the computer to calculate a busyness factor for each resource in response to the number of requests being serviced; and
code means for causing the computer to select the least busy resource to service the consumer group requests based on the consumer load and the busyness factor.

22. A system for dynamic load balancing resource allocation, comprising:
a resource to be allocated for servicing consumer- groups requests; and
a request arbitrator, including
means for determining an actual allocation of the resource for a present operational period,
means for determining a temporary allocation of the resource for a next operational period relative to the desired allocation and the actual allocation,
means for allocating the resources to the consumer group requests in the next operational period according to the temporary allocation, and
means for selecting consumer group requests to be serviced by the resource based upon the amount of requests being presently serviced.

23. The system of claim 22 wherein there are at least two resources, and wherein the request arbitrator further includes
means for calculating a consumer load for each consumer group in response to the number of consumer groups requests being serviced, wherein each consumer group request is associated with a consumer group,
means for calculating a busyness factor for each resource in response to tile number of requests being serviced, and
means for selecting tile least busy resource to service the consumer group requests based on the consumer load and the busyness factor.

24. The system of claim 23 wherein the request arbitrator is further configured with means for keeping track of binding between consumer groups and resources.

25. The system of claim 23 wherein the request arbitrator is further configured with means for matching consumer group requests for a particular resource and its request queue.

26. The system of claim 23 wherein the request arbitrator is configured for being interrupt driven.

27. The system of claim 24 wherein the request arbitrator is further configured with
means for detecting a completion interrupt, and
means, responsive to the completion interrupt, for identifying consumer groups requests having a particular binding and queuing them onto a request servicing queue.

28. The system of claim 24 wherein the request arbitrator is further configured with means for breaking an existing binding between a consumer group and the resource and for establishing a new binding.

29. A system for dynamic load balancing resource allocation, comprising:
a resource to be allocated for servicing consumer groups requests; and
a request arbitrator, including
logic operable to determine an actual allocation of the resource for a present operational period,
logic operable to determine a temporary allocation of the resource for a next operational period relative to the desired allocation and the actual allocation,
logic operable to allocate the resources to the consumer group requests in the next operational period according to the temporary allocation, and
logic operable to select consumer group requests to be serviced by the resource based upon the amount of requests being presently serviced.

30. The system of claim 29 wherein there are at least two resources, and wherein the request arbitrator further includes
logic operable to calculate a consumer load for each consumer group in response to the number of consumer groups requests being serviced, wherein each consumer group request is associated with a consumer group,
logic operable to calculate a busyness factor for each resource in response to the number of requests being serviced, and
logic operable to select the least busy resource to service the consumer group requests based on the consumer load and the busyness factor.
